(19) United States
(12) Patent Application Publication
(10) Pub. No.: US 2026/0287436 A1
(43) Pub. Date: Sep. 24, 2026

(54) ELECTROMAGNETIC WAVE SENSOR

(71) Applicant: TDK Corporation, Tokyo (JP)

(72) Inventors: Shinji HARA, Tokyo (JP); Susumu AOKI, Tokyo (JP); Naoki OHTA, Tokyo (JP); Takahiro NAKAGAWA, Tokyo (JP)

(73) Assignee: TDK Corporation, Tokyo (JP)

(21) Appl. No.: 19/573,173

(22) Filed: Mar. 20, 2026

(30) Foreign Application Priority Data
Mar. 24, 2025 (JP) 2025-048847

(51) Int. Cl. G01J 5/20

(52) U.S. Cl. CPC G01J 5/20

(57) ABSTRACT

An electromagnetic wave sensor comprises first wirings that extend in a first direction, second wirings that extend in a second direction, and bolometers. The thermal resistance of the second wiring per unit length in a direction of extension of the second wirings is lower than the thermal resistance of the first wirings per unit length in a direction of extension of the first wirings. One bolometer is physically connected to a first bolometer adjacent to the one bolometer in the first direction via one first wiring, physically connected to a second bolometer adjacent to the one bolometer in the second direction via one second wiring, and physically connected to the first bolometer via another second wiring adjacent to the one second wiring in the first direction.

### FIELD

This application claims the benefit of Japanese Priority Patent Application No. 2025-048847 filed on Mar. 24, 2025, the entire contents of which are incorporated herein by reference.

The present disclosure relates to an electromagnetic wave sensor.

### BACKGROUND

JP 2024-073823 A describes an electromagnetic wave sensor that comprises electromagnetic wave detection elements that are arranged in a two-dimensional array, first wirings that extend in a first direction, and second wirings that extend in a second direction that is different from the first direction. Each electromagnetic wave detection element is electrically connected to one of the first wirings and one of the second wirings.

### SUMMARY

The electromagnetic wave sensor of the present disclosure comprises first wirings that extend in a first direction, second wirings that extend in a second direction that is different from the first direction, and bolometers. The thermal resistance of the second wirings per unit length in a direction of extension of the second wirings is lower than the thermal resistance of the first wirings per unit length in a direction of extension of the first wirings. The first wirings include one first wiring, and second wirings include one second wiring and another second wiring adjacent to the one second wiring in the first direction. The bolometers include one bolometer, a first bolometer adjacent to the one bolometer in the first direction, and a second bolometer adjacent to the one bolometer in the second direction. The one bolometer is physically connected to the first bolometer via the one first wiring, physically connected to the second bolometer via the one second wiring, and physically connected to the first bolometer via the another second wiring.

### BRIEF DESCRIPTION OF THE DRAWINGS

The accompanying drawings are included to provide a further understanding of the disclosure and are incorporated in and constitute a part of this specification. The drawings illustrate example embodiments and together with the specification explain the principles of the technology.

FIG. 1 is a schematic side view of the electromagnetic wave sensor of the first embodiment of the present disclosure;

FIG. 2A is a partial schematic plan view of the electromagnetic wave sensor shown in FIG. 1;

FIGS. 2B to 2E are partial schematic cross-sectional views of the electromagnetic wave sensor shown in FIG. 2A;

FIG. 3A is a partial schematic plan view of the electromagnetic wave sensor of Comparative Example 1;

FIGS. 3B to 3E are partial schematic cross-sectional views of the electromagnetic wave sensor shown in FIG. 3A;

FIG. 4A is a conceptual diagram showing the conduction of heat in the electromagnetic wave sensor of the first embodiment;

FIG. 4B is a conceptual diagram showing the conduction of heat in the electromagnetic wave sensor of Comparative Example 1;

FIGS. 5A and 5B are schematic side views of the electromagnetic wave sensor of a second embodiment of the present disclosure;

FIG. 6A is a partial schematic plan view of the electromagnetic wave sensor shown in FIG. 5A;

FIGS. 6B to 6E are partial schematic cross-sectional views of the electromagnetic wave sensor shown in FIG. 6A;

FIG. 7A is a partial schematic plan view of the electromagnetic wave sensor of Comparative Example 2; and

FIGS. 7B to 7E are partial schematic cross-sectional views of the electromagnetic wave sensor shown in FIG. 7A.

### DETAILED DESCRIPTION

Heat generated by absorption of incident electromagnetic waves in one electromagnetic wave detection element is conducted to surrounding electromagnetic wave detection elements through the first and second wirings. If the first and second wirings have different heat transfer properties, the amount of the heat that is conducted to adjacent electromagnetic wave detection elements in the first direction and the amount of the heat that is conducted to adjacent electromagnetic wave detection elements in the second direction may differ from each other. This difference can easily cause anisotropy in the temperature distribution obtained by the electromagnetic wave sensor.

It is desirable to provide an electromagnetic wave sensor that is less prone to anisotropy in temperature distribution.

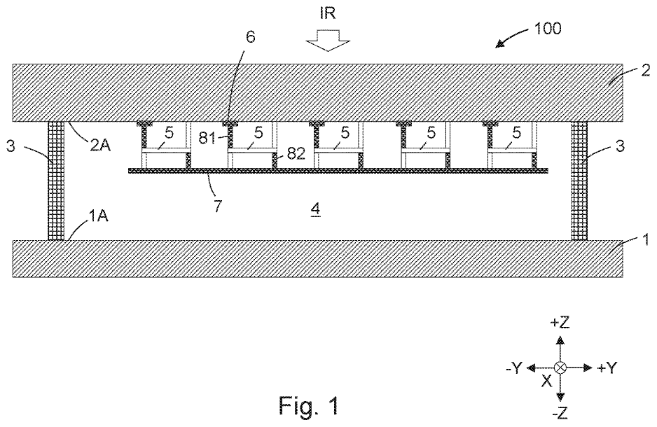

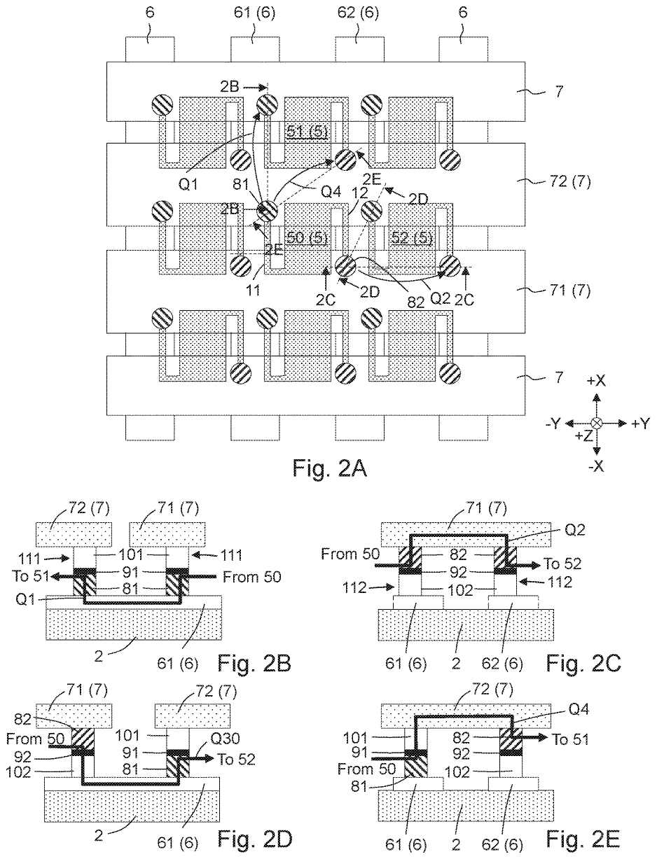

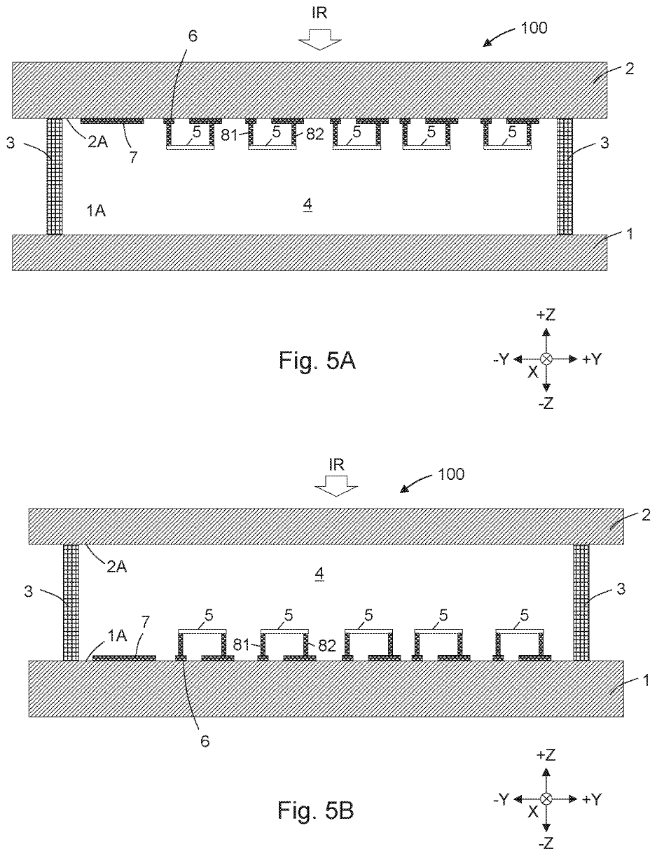

Embodiments of an electromagnetic wave detection element of the present disclosure and an electromagnetic wave sensor provided with this electromagnetic wave detection element are next described with reference to the drawings. The electromagnetic wave detection element (bolometer) of the present disclosure detects electromagnetic waves. The drawings are schematic diagrams illustrating the present disclosure, and in some cases, the shapes and dimensions of the elements in the drawings may not necessarily coincide. In the following description and drawings, the X-direction (also referred to as the “first direction”) and the Y-direction (also referred to as the “second direction”) are parallel to principal surface 1A of first substrate 1 and principal surface 2A of second substrate 2. Principal surface 1A is the surface of first substrate 1 that faces second substrate 2. Principal surface 2A is the surface of second substrate 2 that faces first substrate 1. In the present embodiment, the X-direction and the Y-direction are orthogonal to each other, and the Y-direction can be any direction different from the X-direction. The Z-direction (also referred to as the “third direction”) is orthogonal to the X-direction and the Y-direction and is perpendicular to principal surface 1A of first substrate 1 and principal surface 2A of second substrate 2. The Z-direction may also be referred to as the film thickness direction of electromagnetic wave detection elements 5. As shown in the drawings, the X-direction may be distinguished as the +X-direction and the −X-direction, the Y-direction as the +Y direction and the −Y-direction, and the Z-direction as the +Z-direction and the −Z-direction. The +Z-direction is the direction from first substrate 1 to second substrate 2, and the −Z-direction is the direction from second substrate 2 to first substrate 1. The up-down orientation of the +Z-direction in FIGS. 1 and 5A is opposite to the orientation of the +Z-direction in FIGS. 2B to 2E, 3B to 3E, 6B to 6E, and 7B to 7E.

The following embodiments are directed to an infrared sensor in which electromagnetic wave detection elements (bolometers) are arranged in a two-dimensional array. The infrared sensor mainly detects long-wavelength infrared rays. The wavelength of long-wavelength infrared rays is approximately 8 to 14 μm. Infrared sensors of this type are mainly used as image sensors for infrared cameras. Infrared cameras can be used as night-vision scopes and night-vision goggles in dark places and can also be used as sensors for measuring the temperatures of people and objects. The electromagnetic waves to be detected are not limited to infrared rays but can be, for example, terahertz waves with wavelengths of 100 μm to 1 mm.

### First Embodiment

### Overall Configuration

FIG. 1 is a schematic side view of electromagnetic wave sensor 100 of the present embodiment. In FIG. 1, arm parts are not shown. In FIG. 1, five electromagnetic wave detection elements 5 are arranged in the Y-direction, but as described below, the number of electromagnetic wave detection elements 5 is not limited. Electromagnetic wave sensor 100 comprises first substrate 1 and second substrate 2 that are arranged opposite each other, and side walls 3 that both connect and encircle first substrate 1 and second substrate 2 in the circumferential direction. First substrate 1, second substrate 2, and side walls 3 form a sealed internal space 4. Electromagnetic wave detection elements 5 that function as the sensing part of electromagnetic wave sensor 100, first wirings 6 that extend in the X-direction, and second wirings 7 that extend in the Y-direction are provided in internal space 4. Electromagnetic wave detection elements 5 absorb incident electromagnetic waves and convert the electromagnetic waves into heat for detection. Electromagnetic wave detection elements 5 are bolometers. Because internal space 4 is under negative pressure or in a vacuum, this configuration can prevent or reduce convection of gases in inner space 4 and thus reduce the thermal effect upon electromagnetic wave detection elements 5.

First substrate 1 is mainly formed of a silicon substrate. First substrate 1 is equipped with internal wiring (not shown) and electrical circuits such as readout ICs (ROICs) that read the output signals of electromagnetic wave detection elements 5. Pads (not shown) are formed on the outer sides of side walls 3 of first substrate 1 for input from and output to the outside. The pads are electrically connected to electrical circuits by internal wiring. Second substrate 2 is also formed mainly of a silicon substrate. Second substrate 2 is the substrate on the side of incidence of electromagnetic waves IR to be detected and supports electromagnetic wave detection elements 5. Second substrate 2 transmits electromagnetic waves IR and thus allows the incidence of electromagnetic waves IR to electromagnetic wave detection elements 5. First substrate 1 and second substrate 2 may be germanium substrates that transmit electromagnetic waves.

Electromagnetic wave sensor 100 comprises first wirings 6 that extend in the X-direction, and second wirings 7 that extend in the Y-direction. First wirings 6 and second wirings 7 are supported by second substrate 2. First wirings 6 are provided on second substrate 2 and second wirings 7 are provided at a distance in the −Z-direction from second substrate 2. First wirings 6 are on one side (the +Z-direction side) of electromagnetic wave detection elements 5 in the Z-direction, and second wirings 7 are on the other side (the −Z-direction side) of electromagnetic wave detection elements 5 in the Z-direction. First wirings 6 and second wirings 7 are electrically connected to the ROICs of first substrate 1 by electrical connection members (not shown). First wirings 6 and second wirings 7 maybe made of metals such as Al, Cu, Au, and Ag, alloys mainly composed of these metals, and conductive nitrides such as TiN, ZrN, WN, and CrN.

FIG. 2A is a partial plan view of electromagnetic wave sensor 100 viewed from the −Z-direction and toward the +Z-direction, FIG. 2B is a schematic cross-sectional view taken along line 2B-2B of FIG. 2A, FIG. 2C is a schematic cross-sectional view taken along line 2C-2C of FIG. 2A, FIG. 2D is a schematic cross-sectional view taken along line 2D-2D of FIG. 2A, and FIG. 2E is a schematic cross-sectional view taken along line 2E-2E of FIG. 2A. The positions in the Z-direction of electromagnetic wave detection elements 5, first and second arm parts 11 and 12, and first and second pillar portions 81 and 82 are between the positions in the Z-direction of first wirings 6 and the positions in the Z-direction of second wirings 7, and FIG. 2A shows these elements with solid lines. In FIGS. 2B to 2E, first columnar bodies 111, second columnar bodies 112, first wirings 6, second wirings 7, and second substrate 2 are shown selectively. In FIGS. 2B to 2E, first and second arm parts 11 and 12 are not shown but each first arm part 11 is connected to the end of a corresponding first pillar portion 81 on the first insulation layer-91 side, and each second arm part 12 is connected to the end of a corresponding second pillar portion 82 on the second insulation layer 92 side (that is, first arm parts 11 and second arm parts 12 partially overlap the arrows that indicate the conduction path of heat). Electromagnetic wave detection elements 5 are arranged to form a two-dimensional grid array. The temperature detection film of each of electromagnetic wave detection elements 5 (see below) constitutes one cell or pixel in the array. The number of matrices in the array includes, but is not limited to, for example, 640 rows by 480 columns or 1024 rows by 768 columns.

### Configuration of Electromagnetic Wave Detection Elements 5

As shown in FIG. 2A, each electromagnetic wave detection element 5 is connected to first and second arm parts 11 and 12 that support that electromagnetic wave detection element 5. Although not shown in the drawings, each electromagnetic wave detection element 5 includes a temperature detection film, a dielectric layer, and two electrode layers. The temperature detection film is formed from, for example, a thermistor film, and the thermistor film is made of, for example, at least one of vanadium oxide, amorphous silicon, polycrystalline silicon, oxide with a spinel-type crystal structure containing manganese, titanium oxide, yttrium-barium-copper oxide, graphene, and a nanocarbon material such as carbon nanotubes. The temperature detection film may be a thermocouple film, a thermopile film, a diode film such as a silicon diode, or a pyroelectric film such as a lead zirconate titanate film. The dielectric layer covers at least a part of the temperature detection film and absorbs the electromagnetic waves to be measured. Electromagnetic wave detection elements 5 may also be of a form in which the dielectric film covering the temperature detection film is omitted and the temperature detection film absorbs the electromagnetic waves to be measured. First and second arm parts 11 and 12 comprise conductive wiring layers. One of the two electrode layers is electrically connected to the temperature detection film and first arm part 11, and the other electrode layer is electrically connected to the temperature detection film and second arm part 12.

Electromagnetic wave sensor 100 comprises columnar and conductive first and second pillar portions 81 and 82. First and second pillar portions 81 and 82 each extend in a direction that includes at least a component in the Z-direction (in the present embodiment, the Z-direction). Each first pillar portion 81 is electrically connected to one corresponding first arm part 11 and one corresponding first wiring 6, and each second pillar portion 82 is electrically connected to one corresponding second arm part 12 and one corresponding second wiring 7. In other words, each of electromagnetic wave detection elements 5 is electrically connected to one corresponding first wiring 6 via first pillar portion 81 and to one corresponding second wiring 7 via second pillar portion 82. As a result, DC current flows between each electromagnetic wave detection element 5 and first wiring 6 via first pillar portion 81 and flows between electromagnetic wave detection element 5 and second wiring 7 via second pillar portion 82. In the present embodiment, the DC current flows in the order of (or in the reverse order of) first wiring 6, first pillar portion 81, first arm part 11, electromagnetic wave detection element 5, second arm part 12, second pillar portion 82, and second wiring 7. First pillar portion 81 supports first arm part 11 and in turn supports electromagnetic wave detection element 5 via first arm part 11. Second pillar portion 82 supports second arm part 12 and in turn supports electromagnetic wave detection element 5 via second arm part 12.

First insulation layer 91 is provided between first pillar portion 81 and second wiring 7 for electrically insulating first pillar portion 81 from second wiring 7. This configuration prevents DC current from flowing between first pillar portion 81 and second wiring 7 through first insulation layer 91. First intermediate layer 101 is provided between first insulation layer 91 and second wiring 7. Second insulation layer 92 is provided between second pillar portion 82 and first wiring 6 for electrically insulating second pillar portion 82 and first wiring 6. This configuration prevents DC current from flowing between second pillar portion 82 and first wiring 6 through second insulation layer 92. Second intermediate layer 102 is provided between second insulation layer 92 and first wiring 6. First and second intermediate layers 101 and 102 are made of conductors but may also be made of insulators. First pillar portion 81, first insulation layer 91, and first intermediate layer 101 make up first columnar body 111 that extends in the Z-direction from first wiring 6 to second wiring 7. First columnar body 111 supports first arm part 11 and in turn supports electromagnetic wave detection element 5 via first arm part 11. First columnar body 111 also supports second wiring 7. Second pillar portion 82, second insulation layer 92, and second intermediate layer 102 make up second columnar body 112 that extends in the Z-direction from first wiring 6 to second wiring 7. Second columnar body 112 supports second arm art 12 and in turn supports electromagnetic wave detection element 5 via second arm part 12. Second columnar body 112 also supports second wiring 7. First pillar portion 81, first insulation layer 91 and first intermediate layer 101 are cylindrical or disc-shaped and concentric with each other, but their shape is not limited. Similarly, second pillar portion 82, second insulation layer 92, and second intermediate layer 102 are cylindrical or disc-shaped and concentric with each other but are not limited in shape.

### Configuration of First Wirings 6 and Second Wirings 7

Next, the configuration of first wirings 6 and second wirings 7 will be further described. In the following description, one of first wirings 6 will be referred to as first wiring 61 (one first wiring), a first wiring 6 adjacent to first wiring 61 in the +Y-direction will be referred to as first wiring 62, one of second wirings 7 will be referred to as second wiring 71 (one second wiring), and a second wiring 7 adjacent to second wiring 71 in the +X-direction will be referred to as second wiring 72 (another second wiring). One of electromagnetic wave detection elements 5 will be referred to as electromagnetic wave detection element 50 (one electromagnetic wave detection element), an electromagnetic wave detection element 5 adjacent to electromagnetic wave detection element 50 in the +X-direction will be referred to as first electromagnetic wave detection element 51, and an electromagnetic wave detection element 5 adjacent to electromagnetic wave detection element 50 in the +Y-direction will be referred to as second electromagnetic wave detection element 52.

Electromagnetic wave detection element 50 and first electromagnetic wave detection element 51 are electrically connected to first wiring 61, and electromagnetic wave detection element 50 and second electromagnetic wave detection element 52 are electrically connected to second wiring 71. Electromagnetic wave detection element 50 is electrically connected to first wiring 61 via first pillar portion 81 and electrically connected to second wiring 71 via second pillar portion 82. First electromagnetic wave detection element 51 is electrically connected to first wiring 61 via first pillar portion 81 and electrically connected to second wiring 72 via second pillar portion 82. Second electromagnetic wave detection element 52 is electrically connected to first wiring 62 via first pillar portion 81 and electrically connected to second wiring 71 via second pillar portion 82.

The thermal resistance of second wirings 7 per unit length in the direction of extension (the Y-direction) of second wirings 7 is lower than the thermal resistance of first wirings 6 per unit length in the direction of extension (the X-direction) of first wirings 6. The electrical resistance of second wirings 7 per unit length in the direction of extension (the Y-direction) of second wirings 7 is lower than the electrical resistance of first wirings 6 per unit length in the direction of extension (the X-direction) of first wirings 6. The values of thermal and electrical resistance vary depending on the material, thickness, width, crystallinity, and substrate material of first wirings 6 and second wirings 7. As shown in FIG. 2B to 2E, in the present embodiment, second wirings 7 have greater thickness (the dimension in the Z-direction) and width (the dimension in the Y-direction of first wirings 6 and the dimension in the X-direction of second wirings 7) than first wirings 6. Either of the thickness or width of second wirings 7 may be greater than that of first wirings 6.

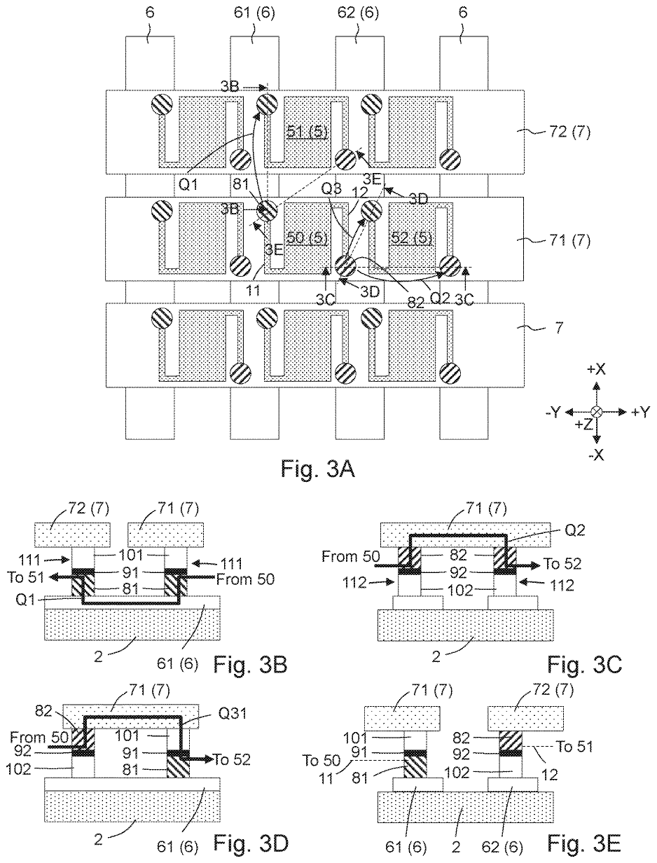

Next, the manner of conducting the heat generated in electromagnetic wave detection element 50 to the surrounding electromagnetic wave detection elements 5 is next described in contrast to Comparative Example 1. FIG. 3A is a partial plan view of the electromagnetic wave sensor of Comparative Example 1 as viewed in the Z-direction, FIG. 3B is a schematic cross-sectional view taken along line 3B-3B line of FIG. 3A, FIG. 3C is a schematic cross-sectional view taken along line 3C-3C of FIG. 3A, FIG. 3D is a schematic cross-sectional view taken along line 3D-3D of FIG. 3A, and FIG. 3E is a schematic cross-sectional view taken along line 3E-3E of FIG. 3A. In FIG. 3A, electromagnetic wave detection elements 5, first and second arm parts 11 and 12, and first and second pillar portions 81 and 82 are shown with solid lines. In FIGS. 3B to 3E, first columnar bodies 111, second columnar bodies 112, first wirings 6, second wirings 7, and second substrate 2 are shown selectively. Although first and second arm parts 11 and 12 are not shown in FIGS. 3B to 3D, each first arm part 11 is connected to the end of corresponding first pillar portion 81 on the first insulation layer 91 side, and each second arm part 12 is connected to the end of corresponding second pillar portion 82 on the second insulation layer 92 side (that is, first and second arm parts 11 and 12 overlap with the arrows that indicate the paths of heat conduction). As shown in FIG. 3A, in Comparative Example 1, first pillar portion 81 that electrically connects electromagnetic wave detection element 50 to first wiring 61 overlaps with second wiring 71, second pillar portion 82 that electrically connects electromagnetic wave detection element 50 to second wiring 71 overlaps with second wiring 71, and second pillar portion 82 that electrically connects electromagnetic wave detection element 51 to second wiring 72 overlaps with second wiring 72. In contrast, in the present embodiment, when viewed form the Z-direction as shown in FIG. 2A, first pillar portion 81 that electrically connects electromagnetic wave detection element 50 to first wiring 61 and second pillar portion 82 that electrically connects first electromagnetic wave detection element 51 to second wiring 72 overlap second wiring 72, and second pillar portion 82 that electrically connects first electromagnetic wave detection element 51 to second wiring 71 overlaps with second wiring 71.

When electromagnetic waves are incident to electromagnetic wave detection element 50, the temperature detection film and dielectric layer of electromagnetic wave detection element 50 absorb the electromagnetic waves and generate heat. Most of the generated heat stays inside electromagnetic wave detection element 50 but some heat is conducted to surrounding electromagnetic wave detection elements 5 through, for example, first wirings 6 and second wirings 7 and raises the temperature of the temperature detection film of the surrounding electromagnetic wave detection elements 5. The manner by which the heat generated in electromagnetic wave detection element 50 is conducted to first electromagnetic wave detection element 51 and second electromagnetic wave detection element 52 is next described.

Referring to FIG. 2B and FIG. 3B, in both the present embodiment and Comparative Example 1, the heat generated in electromagnetic wave detection element 50 is conducted to first electromagnetic wave detection element 51 by way of first pillar portion 81 that electrically connects electromagnetic wave detection element 50 to first wiring 61, first wiring 61, and first pillar portion 81 that electrically connects first electromagnetic wave detection element 51 to first wiring 61. In other words, electromagnetic wave detection element 50 and first electromagnetic wave detection element 51 are thermally connected via first wiring 61. The heat conducted to first electromagnetic wave detection element 51 by way of this path is the same in both the present embodiment and Comparative Example 1, and this heat is hereinafter referred to as heat Q1.

Referring to FIG. 2C and FIG. 3C, in both the present embodiment and Comparative Example 1, the heat generated in electromagnetic wave detection element 50 is conducted to second electromagnetic wave detection element 52 by way of second pillar portion 82 that electrically connects electromagnetic wave detection element 50 to second wiring 71, second wiring 71, and second pillar portion 82 that electrically connects second electromagnetic wave detection element 52 to second wiring 71. In other words, electromagnetic wave detection element 50 and second electromagnetic wave detection element 52 are thermally connected via second wiring 71. The heat conducted to second electromagnetic wave detection element 52 by way of this path is the same in both the present embodiment and Comparative Example 1, and this heat is hereinafter referred to as heat Q2.

Referring to FIG. 2D, in the present embodiment, the heat generated in electromagnetic wave detection element 50 is conducted to second electromagnetic wave detection elements 52 by way of second insulation layer 92, second intermediate layer 102, first wiring 61, and first pillar portion 81 that electrically connects second electromagnetic wave detection element 52 to first wiring 62. This heat is hereinafter referred to as Q30. Referring to FIG. 3D, in Comparative Example 1, the heat generated in electromagnetic wave detection element 50 is conducted to second electromagnetic wave detection element 52 by way of second pillar portion 82 that electrically connects electromagnetic wave detection element 50 to second wiring 71, second wiring 71, first intermediate layer 101, and first insulation layer 91. This heat is hereinafter referred to as Q31.

Referring to FIG. 2E, in the present embodiment, electromagnetic wave detection element 50 is physically connected to first electromagnetic wave detection element 51 by way of at least first insulation layer 91, second wiring 72, and second pillar portion 82 that electrically connects first electromagnetic wave detection element 51 to second wiring 72. Therefore, in the present embodiment, the heat generated in electromagnetic wave detection elements 50 is conducted to first electromagnetic wave detection element 51 by way of first insulation layer 91, first intermediate layer 101, second wiring 72, and second pillar portion 82 that electrically connects first electromagnetic wave detection element 51 to second wiring 72. In other words, electromagnetic wave detection element 50 is thermally connected to first electromagnetic wave detection element 51 via at least first insulation layer 91, second wiring 72, and second pillar portion 82 that electrically connects first electromagnetic wave detection element 51 to second wiring 72. This heat is referred to as Q4. Referring to FIG. 3E, in the cross-section shown in FIG. 3E of Comparative Example 1, there is no conduction path of heat between electromagnetic wave detection element 50 and first electromagnetic wave detection element 51 via first wiring 6 or second wiring 7, and the amount of heat at this cross-sectional position that is conducted from electromagnetic wave detection element 50 to first electromagnetic wave detection element 51 is negligibly small.

The thermal resistance per unit length of second wiring 7 in the direction of extension (the Y-direction) of second wiring 7 is smaller than the thermal resistance of first wiring 6 per unit length in the direction of extension (the X-direction) of first wiring 6. Since heat Q2 passes through second wiring 7 and heat Q1 passes through first wiring 6, the general trend is Q2>Q1. Also, heat Q30 passes through second insulation layer 92 and heat Q31 passes through first insulation layer 91 as well, but because heat Q30 passes through first wiring 6 and heat Q31 passes through second wiring 7, the general tendency is Q31>Q30.

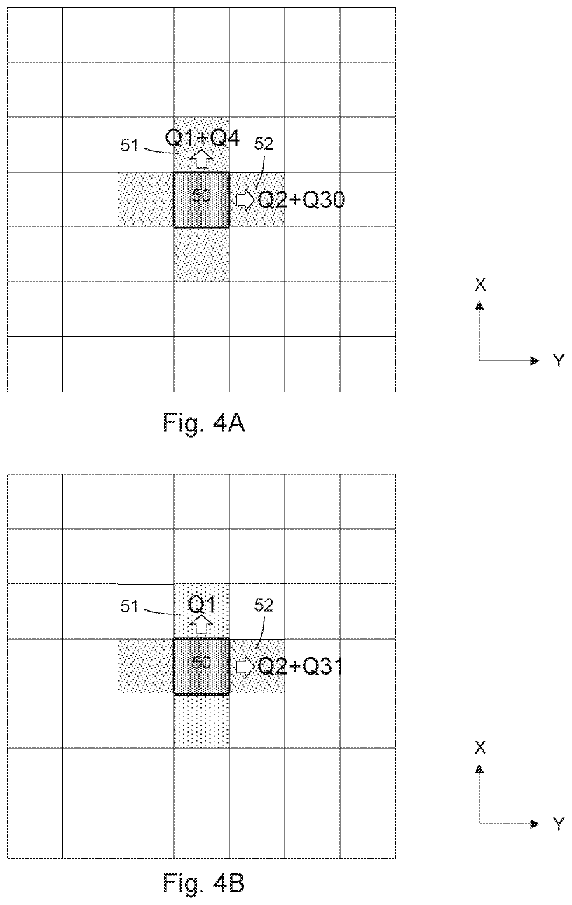

FIG. 4A schematically shows the heat that is conducted from electromagnetic wave detection element 50 to first and second electromagnetic wave detection elements 51 and 52 in the present embodiment. FIG. 4B schematically shows the heat that is conducted from electromagnetic wave detection element 50 to first and second electromagnetic wave detection elements 51 and 52 in Comparative Example 1. The square cells in the drawings schematically show electromagnetic wave detection elements 5. In Comparative Example 1, the heat that is conducted from electromagnetic wave detection element 50 to first electromagnetic wave detection element 51 is Q1, and the heat that is conducted from electromagnetic wave detection element 50 to second electromagnetic wave detection element 52 is Q2+Q31. Since Q1<Q2+Q31, more heat is conducted to the temperature detection film of second electromagnetic wave detection element 52 than to the temperature detection film of first electromagnetic wave detection element 51. As a result, anisotropy tends to occur in the temperature distribution obtained by the electromagnetic wave sensor.

In the present embodiment, the heat that is conducted from electromagnetic wave detection element 50 to first electromagnetic wave detection element 51 is Q1+Q4, and the heat that is conducted from electromagnetic wave detection element 50 to second electromagnetic wave detection element 52 is Q2+Q30. The heat that is conducted from electromagnetic wave detection element 50 to first electromagnetic wave detection element 51 increases, and because Q31>Q30, the heat that is conducted from electromagnetic wave detection element 50 to second electromagnetic wave detection element 52 decreases compared to Comparative Example 1. Thus, the difference between the heat that is conducted from electromagnetic wave detection element 50 to first electromagnetic wave detection element 51 and the heat that is conducted from electromagnetic wave detection element 50 to second electromagnetic wave detection element 52 is decreased compared to Comparative Example 1, and this decrease mitigates the anisotropy in the temperature distribution obtained by electromagnetic wave sensor 100.

### Second Embodiment

The second embodiment is next described with reference to FIGS. 5A and 5B, 6A to 6E, and 7A to 7E. The present embodiment is described below focusing on points that differ from the first embodiment. Configurations and effects that are the same as those of the first embodiment are omitted from the explanation. FIGS. 5A and 5B are schematic side views of electromagnetic wave sensor 100. In FIGS. 5A and 5B, the arm parts are not shown. FIG. 5A shows electromagnetic wave sensor 100 of the present embodiment, and FIG. 5B shows a modification of electromagnetic wave sensor 100. In both configurations, first wirings 6 and second wirings 7 are on the same side of electromagnetic wave detection elements 5 in the Z-direction. In the second embodiment, electromagnetic wave detection elements 5, first wirings 6, and second wirings 7 are provided on second substrate 2. In the modification, electromagnetic wave detection elements 5, first wirings 6, and second wirings 7 are provided on first substrate 1. The following description is based on the configuration shown in FIG. 5A but applies equally to the configuration shown in FIG. 5B.

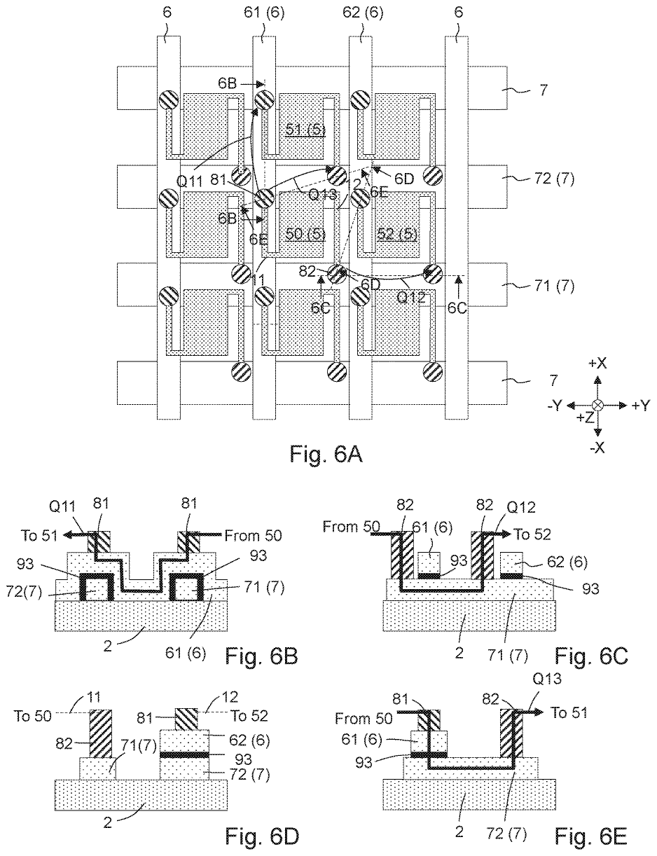

FIG. 6A is a partial plan view of electromagnetic wave sensor 100 of the present embodiment viewed from the Z-direction, FIG. 6B is a schematic cross-sectional view taken along line 6B-6B of FIG. 6A, FIG. 6C is a schematic cross-sectional view taken along line 6C-6C of FIG. 6A, FIG. 6D is a schematic cross-sectional view taken along line 6D-6D of FIG. 6A, and FIG. 6E is a schematic cross-sectional view taken along line 6E-6E of FIG. 6A. In FIG. 6A, electromagnetic wave detection elements 5, first and second arm parts 11 and 12, and first and second pillar portions 81 and 82 are shown with solid lines. In FIGS. 6B to 6E, first and second pillar portions 81 and 82, insulation layers 93, first wirings 6, second wirings 7, and second substrate 2 are shown selectively. In FIGS. 6B, 6C, and 6E, first and second arm parts 11 and 12 are not shown, but first arm parts 11 are connected to the ends of first pillar portions 81 that are apart from second substrate 2, and second arm portions 12 are connected to the ends of second pillar portions 82 that are apart from second substrate 2 (i.e., arm parts 11 and 12 overlap with the arrows indicating the heat conduction paths). As shown in FIG. 6B, first wirings 6 and second wirings 7 extend at the same position in the Z-direction and three-dimensionally cross at crossing portions. At the crossing portions, insulation layers 93 are provided between first wirings 6 and second wirings 7. Although not shown in the drawings, first wirings 6 and second wirings 7 may extend at different positions from each other in the Z-direction, in which case, insulation layers 93 are also provided between first wirings 6 and second wirings 7. The thermal resistance of second wirings 7 per unit length of second wirings 7 in the direction of extension (the Y-direction) of second wirings 7 is lower than the thermal resistance of first wirings 6 per unit length in the direction of extension (the X-direction) of first wirings 6. The electrical resistance of second wirings 7 per unit length in the direction of extension (the Y-direction) of second wirings 7 is lower than the electrical resistance of first wirings 6 per unit length in the direction of extension (the X-direction) of first wirings 6. For example, when first wiring 6 passes over second wiring 7 at a three-dimensional crossing portion as shown in FIG. 6B, the thermal resistance and the electrical resistance of first wiring 6 per unit length in the direction of extension (the X-direction) of first wiring 6 increase because paths in the Z-direction are generated. Also, the cross-sectional area of first wiring 6 may decrease at the rising portion compared to other portions.

Each first pillar portion 81 is electrically connected to one corresponding first arm part 11 and a corresponding first wiring 6, and each second pillar portion 82 is electrically connected to one corresponding second arm part 12 and a corresponding second wiring 7. Electromagnetic wave detection element 50 is electrically connected to first wiring 61 via one first pillar portion 81 and electrically connected to second wiring 71 via one second pillar portion 82. First electromagnetic wave detection element 51 is electrically connected to first wiring 61 via another first pillar portion 81 and electrically connected to second wiring 72 via another second pillar portion 82. Second electromagnetic wave detection element 52 is electrically connected to first wiring 62 via yet another first pillar portion 81 and electrically connected to second wiring 71 via yet another second pillar portion 82. The present embodiment is not provided with first and second insulation layers 91 and 92 and first and second intermediate layers 101 and 102 in the first embodiment and the modification thereof.

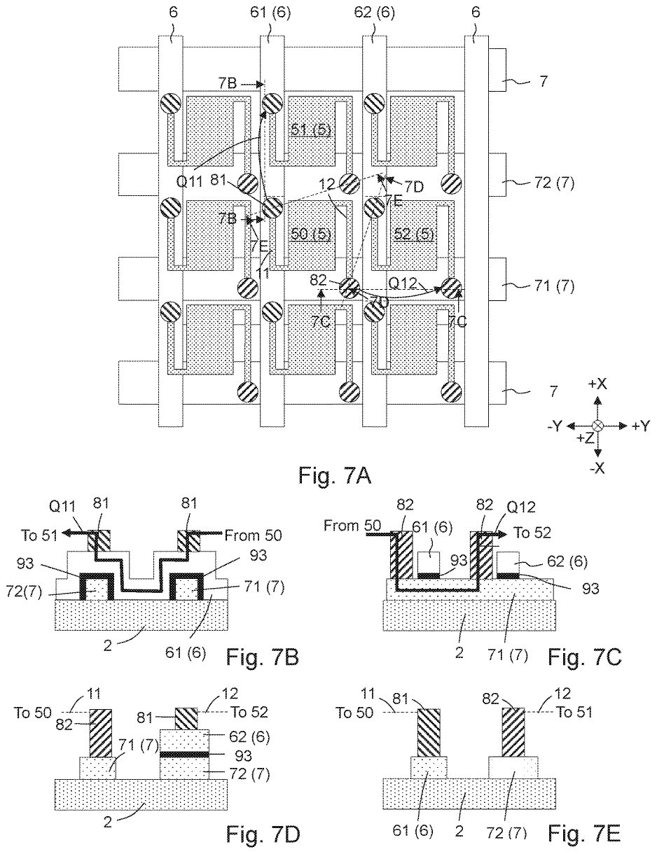

Next, the manner by which the heat generated in electromagnetic wave detection element 50 is conducted to the surrounding electromagnetic wave detection elements 5 will be described in contrast with Comparative Example 2. FIG. 7A is a partial plan view of the electromagnetic wave sensor of Comparative Example 2 viewed from the Z-direction, FIG. 7B is a schematic cross-sectional view taken along line 7B-7B of FIG. 7A, FIG. 7C is a schematic cross-sectional view taken along line 7C-7C of FIG. 7A, FIG. 7D is a schematic cross-sectional view taken along line 7D-7D of FIG. 7A, and FIG. 7E is a schematic cross-sectional view taken along line 7E-7E of FIG. 7A. In FIG. 7A, electromagnetic wave detection elements 5, first and second arm parts 11 and 12, and first and second pillar portions 81 and 82 are shown with solid lines. In FIGS. 7B to 7E, first and second pillar portions 81 and 82, insulation layers 93, first wirings 6, second wirings 7, and second substrate 2 are shown selectively. In FIGS. 7B and 7C, first and second arm parts 11 and 12 are not shown, but first arm parts 11 are connected to the ends of first pillar portions 81 that are apart from second substrate 2, and second arm parts 12 are connected to the ends of second pillar portions 82 that are apart from second substrate 2 (i.e., arm parts 11 and 12 overlap with the arrows indicating the heat conduction paths). In Comparative Example 2, when viewed from the Z-direction as shown in FIG. 7A, first pillar portion 81 that electrically connects electromagnetic wave detection element 50 to first wiring 61 does not overlap with any second wiring 7, while second pillar portion 82 that electrically connects electromagnetic wave detection element 50 to second wiring 71 overlaps with second wiring 71. In contrast, in the present embodiment, when viewed form the Z-direction as shown in FIG. 6A, first pillar portion 81 that electrically connects electromagnetic wave detection element 50 to first wiring 61 and second pillar part 82 that electrically connects first electromagnetic wave detection element 51 to second wiring 72 both overlap with second wiring 72, and second pillar portion 82 that electrically connects electromagnetic wave detection element 50 to second wiring 71 overlaps with second wiring 71.

Referring to FIGS. 6B and 7B, in both the present embodiment and Comparative Example 2, the heat that is generated in electromagnetic wave detection element 50 is conducted to first electromagnetic wave detection element 51 by way of first pillar portion 81 that electrically connects electromagnetic wave detection element 50 to first wiring 61, first wiring 61, and first pillar portion 81 that electrically connects electromagnetic wave detection element 51 to first pillar portion 81. In other words, electromagnetic wave detection element 50 is thermally connected to first electromagnetic wave detection element 51 via first wiring 61. The heat transferred to first electromagnetic wave detection element 51 via this path is the same in both the present embodiment and Comparative Example 2, and this heat is hereinafter referred to as heat Q11.

Referring to FIGS. 6C and 7C, in both the present embodiment and Comparative Example 2, the heat that is generated in electromagnetic wave detection element 50 is conducted to second electromagnetic wave detection element 52 by way of second pillar portion 82 that electrically connects electromagnetic wave detection element 50 to second wiring 71, second wiring 71, and second pillar portion 82 that electrically connects electromagnetic wave detection element 52 to second wiring 71. In other words, electromagnetic wave detection element 50 and second electromagnetic wave detection element 52 are thermally connected via second wiring 71. The heat that is conducted to second electromagnetic wave detection element 52 via this path is the same in both the present embodiment and Comparative Example 2, and this heat is hereinafter referred to as heat Q12.

Referring to FIGS. 6D and 7D, in both the present embodiment and Comparative Example 2, there is no conduction path of heat between electromagnetic wave detection element 50 and second electromagnetic wave detection element 52 via first wiring 6 or second wiring 7, and the amount of heat that is conducted from electromagnetic wave detection element 50 to second electromagnetic wave detection element 52 at this sectional position in the cross sections shown in these drawings is negligibly small. Referring to FIG. 6E, electromagnetic wave detection element 50 in the present embodiment is physically connected to first electromagnetic wave detection element 51 via at least first pillar portion 81 that electrically connects electromagnetic wave detection element 50 to first wiring 61, first wiring 61, insulation layer 93, second wiring 72, and second pillar portion 82 that electrically connects first electromagnetic wave detection element 51 to second wiring 72. Therefore, in the present embodiment, the heat that is generated in electromagnetic wave detection element 50 is conducted to first electromagnetic wave detection element 51 by way of first pillar portion 81 that electrically connects electromagnetic wave detection element 50 to first wiring 61, first wiring 61, insulation layer 93, second wiring 72, and second pillar portion 82 that electrically connects first electromagnetic wave detection element 51 to second wiring 72. In other words, electromagnetic wave detection element 50 is thermally connected to first electromagnetic wave detection element 51 via at least first pillar portion 81 that electrically connects electromagnetic wave detection element 50 to first wiring 61, first wiring 61, insulation layer 93, second wiring 72, and second pillar portion 82 that electrically connects first electromagnetic wave detection element 51 to second wiring 72. This heat is referred to as Q13. Referring to FIG. 7E, in the cross section of Comparative Example 2 shown in FIG. 7E, there is no conduction path of heat between electromagnetic wave detection element 50 and first electromagnetic wave detection element 51 via first wiring 6 or second wiring 7, and the amount of heat that is conducted from electromagnetic wave detection element 50 to first electromagnetic wave detection element 51 at this sectional position in the cross section is negligibly small.

Since heat Q12 passes through second wiring 7 and heat Q11 passes through first wiring 6, the general tendency is Q12>Q11. In Comparative Example 2, the heat that is conducted from electromagnetic wave detection element 50 to first electromagnetic wave detection element 51 is Q11, and the heat that is conducted from electromagnetic wave detection element 50 to second electromagnetic wave detection element 52 is Q12. Since Q11<Q12, more heat is conducted to the temperature detection film of second electromagnetic wave detection element 52 than to the temperature detection film of first electromagnetic wave detection element 51. The heat that is conducted to the temperature detection film of second electromagnetic wave detection element 52 is Q12. As a result, anisotropy tends to occur in the temperature distribution obtained by the electromagnetic wave sensor.

In the present embodiment, the heat that is conducted from electromagnetic wave detection element 50 to first electromagnetic wave detection element 51 is Q11+Q13, and the heat that is conducted from electromagnetic wave detection element 50 to second electromagnetic wave detection element 52 is Q12. Accordingly, the difference between the heat that is conducted from electromagnetic wave detection element 50 to first electromagnetic wave detection element 51 and the heat that is conducted from electromagnetic wave detection element 50 to second electromagnetic wave detection element 52 is decreased compared to Comparison Example 2, and the anisotropy of the temperature distribution obtained by electromagnetic wave sensor 100 is thereby mitigated.

Although certain embodiments of the present disclosure have been illustrated and described in detail, it will be understood that various changes and modifications can be made therein without departing from the spirit or scope of the appended claims.

### LIST OF REFERENCE NUMERALS

5, 50, 51, 52 electromagnetic wave detection elements
6, 61, 62 first wiring
7, 71, 72 second wiring
81 first pillar portion
82 second pillar portion
91 to 93 insulation layer
100 electromagnetic wave sensor
X first direction
Y second direction
Z third direction

1. An electromagnetic wave sensor, comprising:
first wirings that extend in a first direction;
second wirings that extend in a second direction that is different from the first direction; and
bolometers, wherein
thermal resistance of the second wirings per unit length in a direction of extension of the second wirings is lower than thermal resistance of the first wirings per unit length in a direction of extension of the first wirings,
the first wirings include one first wiring,
the second wirings include one second wiring and another second wiring adjacent to the one second wiring in the first direction,
the bolometers include one bolometer, a first bolometer adjacent to the one bolometer in the first direction, and a second bolometer adjacent to the one bolometer in the second direction, and
the one bolometer is physically connected to the first bolometer via the one first wiring, physically connected to the second bolometer via the one second wiring, and physically connected to the first bolometer via the another second wiring.

2. The electromagnetic wave sensor according to claim 1, wherein, in a third direction that is orthogonal to the first direction and the second direction, the first wirings are on one side of the bolometers, and the second wirings are on another side of the bolometers.

3. The electromagnetic wave sensor according to claim 2, further comprising:
a first pillar portion and a second pillar portion that extend in a direction that includes at least a component in the third direction; and
an insulation layer that is positioned between the first pillar portion and the another second wiring, wherein
the one bolometer is electrically connected to the one first wiring via the first pillar portion,
the first bolometer is electrically connected to the another second wiring via the second pillar portion, and
the one bolometer is physically connected to the first bolometer via at least the insulation layer, the another second wiring, and the second pillar portion.

4. The electromagnetic wave sensor according to claim 2, further comprising:
a first pillar portion and a second pillar portion that extend in a direction that includes at least a component in the third direction, wherein
the one bolometer is electrically connected to the one first wiring via the first pillar portion and electrically connected to the one second wiring via the second pillar portion, and
when viewed from the third direction, the first pillar portion overlaps the another second wiring and the second pillar portion overlaps the one second wiring.

5. The electromagnetic wave sensor according to claim 2, further comprising:
a first pillar portion and a second pillar portion that extend in a direction that includes at least a component in the third direction, wherein
the one bolometer is electrically connected to the one first wiring via the first pillar portion,
the first bolometer is electrically connected to the another second wiring via the second pillar portion, and
when viewed from the third direction, the first pillar portion and the second pillar portion overlap the another second wiring.

6. The electromagnetic wave sensor according to claim 1, wherein
in a third direction that is orthogonal to the first direction and the second direction, the first wirings and the second wirings are on the same side of the bolometers.

7. The electromagnetic wave sensor according to claim 6, further comprising:
a first pillar portion and a second pillar portion that extend in a direction that includes at least a component in the third direction; and
an insulation layer that is positioned between the one first wiring and the another second wiring, wherein
the one bolometer is electrically connected to the one first wiring via the first pillar portion,
the first bolometer is electrically connected to the another second wiring via the second pillar portion, and
the one bolometer is physically connected to the first bolometer via at least the first pillar portion, the one first wiring, the insulation layer, the another second wiring, and the second pillar portion.

8. The electromagnetic wave sensor according to claim 6, further comprising:
a first pillar portion and a second pillar portion that extend in a direction that includes at least a component in the third direction, wherein
the one bolometer is electrically connected to the one first wiring via the first pillar portion and is electrically connected to the one second wiring via the second pillar portion, and
when viewed from the third direction, the first pillar portion overlaps the another second wiring and the second pillar portion overlaps the one second wiring.

9. The electromagnetic wave sensor according to claim 6, further comprising:
a first pillar portion and a second pillar portion that extend in a direction that includes at least a component in the third direction, wherein
the one bolometer is electrically connected to the one first wiring via the first pillar portion,
the first bolometer is electrically connected to the another second wiring via the second pillar portion, and
when viewed from the third direction, the first pillar portion and the second pillar portion overlap the another second wiring.

10. An electromagnetic wave sensor, comprising:
first wirings that extend in a first direction;
second wirings that extend in a second direction that is different from the first direction; and
electromagnetic wave detection elements that absorb incident electromagnetic waves and convert them into heat for detection, wherein
thermal resistance of the second wirings per unit length in the direction of extension of the second wirings is lower than thermal resistance of the first wirings per unit length in the direction of extension of the first wirings,
the first wirings include one first wiring,
the second wirings include one second wiring and another second wiring adjacent to the one second wiring in the first direction,
the electromagnetic wave detection elements include one electromagnetic wave detection element, a first electromagnetic wave detection element adjacent to the one electromagnetic wave detection element in the first direction, and a second electromagnetic wave detection element adjacent to the one electromagnetic wave detection element in the second direction, and
the one electromagnetic wave detection element is physically connected to the first electromagnetic wave detection element via the one first wiring, physically connected to the second electromagnetic wave detection element via the one second wiring, and physically connected to the first electromagnetic wave detection element via the another second wiring.
